(19) United States
(12) Patent Application Publication
(10) Pub. No.: US 2009/0255022 A1
(43) Pub. Date: Oct. 15, 2009

(54) Molded Torso-conforming body armor including method of producing same

(76) Inventors: Barry L. Smith, Cambridge (CA); Chung L. Ting, Kitchener (CA)

Correspondence Address: DOUGLAS S. BISHOP;BISHOP & HEINTZ, P.C., 440 WEST FRONT AT OAK, P.O. BOX 707, TRAVERSE CITY, MI, 49685-0707, US

(21) Appl. No.: 12/313,805

(22) Filed: Nov. 25, 2008

Related U.S. Application Data
(60) Provisional application No. 61/124,074, filed on Apr. 14, 2008.

(51) Int. Cl. F41H 1/02; B29C 43/20; F41H 5/00

(52) U.S. Cl. 2/2.5; 156/245; 89/36.02; 89/36.05

(57) ABSTRACT

Molded body armor panels conformed to fit individual torsos based upon gender or, in custom applications, individual features of a particular male or female torso. The individual body panels are constructed of multiple layers of twill or other unconventional long float woven ballistic fibers with each layer impregnated with a curable adhesive. Additional reinforcement may be supplied in appropriate areas, such as breasts, spine, sternum and edges. The multiple impregnated layers of fabric are placed within a mold conforming to the particular torso contour desired. The long floats of the fabric allows the layers to stretch or compress as required to the particular shape desired. The adhesive is cured in the mold under low heat and low pressure, binding the layers of fabric together, as well as binding the conformed yarns of each individual layer in permanent contour. Interior and exterior coverings for comfort and appearance may be supplied.

### CLAIM OF PRIORITY

Applicant claims the priority of Provisional Application No. 61/124,074, filed Apr. 14, 2008.

### BACKGROUND OF THE INVENTION

The instant invention, Molded Torso Conforming Body Armor Including Method of Producing Same, relates generally to protective body armor and, in particular, to body armor panels conformed to fit torsos of both males and females and, in custom applications, to fit particular torsos of particular individuals, either male or female.

The concept of providing relatively soft, concealable body armor was known as early as 1897, when soft, concealable body armor based on linen, goat wool, and unidirectional silk fibers was introduced. U.S. Pat. No. 3,783,449, to Davis, disclosed the use of high strength ballistic nylon. In general, early vests of this type tended to be heavy and thick, covering only small portions of a torso with protection limited to low energy handgun bullets. Thereafter, it became clear that aramid fibers (those of a class of synthetic aromatic long-chain polyamides capable of extrusion into fibers having resistance to high temperatures and great strength) were far superior to nylon, offering higher performance and greater coverage at lighter weight and less thickness. Because of needs of military and police, the technology has continuously evolved as improved fibers, materials and production have been developed, resulting in better performance with more protective, lighter, thinner and more wearable and user friendly vests, which are able to protect larger portions of the body. Body armor standards have become increasingly stringent as ballistic threats to police and military personnel have increased.

For the most part, past industry innovations in the body armor field have concentrated on developments in the way of torso protection for males. Improvements for females have been largely the result of trying to adopt innovations proven successful in males to females. Little has previously been done successfully to specifically design new body armor for the female form.

The fibers of today's body armor industry are well known. For soft body armor, the current industry primarily uses aromatic polyamide (aramid/para-aramid) fibers usually composed of poly (p-phenlylene terepthalimide) (PPD-T) such as DuPont's Kevlar®, Teijin-Twaron's Twaron®, and Kolon's Heracron®, as well as Ultra High Molecular Weight Polyethylene (UHMWPE) fibers such a Honeywell's Spectra® and Dutch State Mine's Dyneema®.

These fibers come in a wide variety of deniers (gm/9000 meters) currently ranging from 200-3000. Tensile properties vary widely, but can be generally characterized as having tenacities above 22 gm/den, break elongations between 2.5-3.5% and tensile moduli greater than 350 gm/den. Recently, Kamensknolokno's co-polymer aramid also has entered this market, under the names AuTx, Rusar® and Artec®.

While, traditionally, soft body armor manufacturers have utilized a wide variety of conventional plain woven fabrics, various non-woven unidirectional (UD) fiber reinforced flexible resin composites have been introduced. In practice, they are found most commonly incorporated into vest designs with woven aramid fabrics. Such fiber reinforced flexible resin composites are marketed by Honeywell under the name Spectra Shield (UHMPE), Spectra Flex (UHMWPE), and Goldflex (aramid). They are also manufactured by DSM under the name Dyneema (UHMWPE).

More recently, quasi-UD fabrics have been utilized to present high strength “ballistically functional” fibers in a zero or very low weave crimp configuration by utilizing very light non-functional fibers to interlace with the plain weave.

While all of the above examples of prior art have proven valuable in the body armor field, none lend themselves well to forming the compound curves needed to produce a form-fitted female vest conforming to the torso, including breasts, of a female.

Beyond a requirement for the requisite level of ballistic protection with minimal weight and thickness, body armor for females presents additional previously unmet requirements. Body armor must provide support and comfortable fit for a wide variety of female shapes and sizes, as reference to the bra industry demonstrates, where bra manufacturers may list as many as 250 combinations of chest band and bra cup sizes. Further, it is becoming increasingly acknowledged that females require significantly higher blunt trauma protection in the breast area than do males. As an example, experience shows that female breast trauma from seat belts during automobile accidents can lead to life threatening hematomas. Likewise, breast injury can result over time in painful dystropic parenchyma calcifications and can produce lesions which cannot be easily distinguished from malignant tumors. There is even some evidence indicating that trauma to the female breast may be a cause of breast cancer

Since soft body armor, beyond protection from ballistic threats, may also protect (or minimize harm to) the user from such threats as vehicle and aircraft accidents, clubbings, falls, explosions, and knives or other sharp instruments, there is a need in the industry to provide enhanced trauma protection over the female breast area, above and beyond that which current standards provide for males, to provide added protection for females from these non-ballistic threats as well. The known prior art does not meet this significant need.

The current art, also, does not provide appropriate contours for females, so that, when worn, it may easily be concealed. Since the current attempts of the prior art to modify products built initially for males for utilization by females inevitably result in bulky, uncomfortable and usually obvious results, body armor for females has aesthetic, comfort and safety implications. Bulky or non form-fitting body armor reduces the covert appearance of body armor, greatly increasing the risk that an attacker or adversary will attempt to attack the user in areas outside the protective area of the armor. Thus, it is clear, in summary, that the prior art has significantly failed to provide satisfactory body armor for females, and a clear need exists in this area.

It is also well known in the body armor industry that ballistic materials function optimally when the fibers are mobile and may flex and absorb and, thus, dissipate energy rapidly and laterally along long lengths. Further, the more rigid the backing material behind the armor, and the closer to the armor edge that impact may take place, the more difficult it will be to stop a projectile. The prior art, as it currently exists, neither recognizes the need for added protection over hard boney spine and sternum surfaces, nor does it normally provide additional protection for impact closer than three inches from an edge or a border, where the ability to flex, absorb and dissipate is greatly reduced. Accordingly, a need exists, as well, for body armor which provides additional protection along the spine, sternum or other boney areas, as well as along the edges of the particular armor panels.

Because most ballistic fabric for the prior art are plain woven fabric, they do not lend themselves well to molding into complex or concave, or combination thereof, shapes. While some utilization of very loosely woven materials exists, such as that disclosed in U.S. Pat. No. 6,610,617, to Chiou et al, such use of loosely woven fabrics has not been utilized for the purpose of molding, but for the well known principle of simply using many thinner, lighter fabric layers, to produce thinner, lighter vests. Examples of this include both plain weaves and satins. These extremely loose weaves are exceedingly difficult to manage in manufacturing and require stabilization with resins or other means to keep them from falling apart. Usually, additional weaving and handling costs are also incurred. Other attempts of the prior art to provide additional protection for female breasts, include U.S. Pat. No. 5,020,157, to Dyer, in which the addition of a pair of molded cups of more rigid material over the breasts and under the bra are utilized to dissipate trauma-producing energy. Significant disadvantages of this approach, consistent with the prior art, include substantial additional bulk under the vest and bra, reduced comfort and additional cost.

Other attempts to address breast protection for female includes attempts to form breast cups from variously cut, overlapped and stitched ballistic materials. These techniques have resulted, to date, in often at least doubling the armor thickness and stiffness in the area of shaping, and include additional disadvantages, such as creating a higher probability of weak areas, and more vulnerability to penetration at the seams. Significant additional costs which result in this approach with only limited shaping results, are far from the optimum required. U.S. Pat. No. 4,183,097, to Mellian (FIG. 1), discloses cutting groups of aramid plies on curves, then overlapping every several plies, back and forth, for at least one inch, prior to sewing all plies together. Since, as it is generally known that overlapping requires at least a two to three inch overlap to ensure ballistic integrity, such an approach is not optimum. Further, this approach does not address the previously stated disadvantages of other examples of the prior art.

An alternative method of the prior art has also been to fold groups of plies into darts (FIG. 2), without cutting the ballistic material, then sewing the darts, in order to hold them in place. Of all the prior art for female body armor, this technique has seemed the preferred industry practice, because it has a lesser propensity to generate weak areas. It does, however, more than treble the thickness of armor whenever shaping darts are formed. As with the other examples of prior art, this method only partially results in any appreciable confirmation to female shape for the vest, and an additional disadvantage is the asymmetrical reaction of the armor on ballistic impact, sometimes resulting in penetration failures during certification tests. It is not unusual for male armor design to have to have additional layers of ballistic material added to compensate for this problem when the armor is adapted to females. This additionally detracts from comfort and appearance and, additionally, increases cost.

U.S. Pat. No. 5,943,694, to Moreau et al, discloses a previous common industry practice of forming a shaped vest of multiple darts (FIG. 2) and disposing the darts in a manner that they do not overlap each other. The shaped portion of the vest is still trebled, and, other than providing that each fabric layer be darted separately as opposed to darting multiple layers with fewer darts, it is not apparent that any advantage is provided and the disadvantages of the prior art continue to apply.

U.S. Pat. No. 4,578,821, to Zufle, discloses another prior art modification of a male design, wherein horizontal cuts are made in the sides of a vest, with the cut areas overlapped and held with Velcro® to form a horizontal concave form to accommodate female breasts (FIG. 3). Disadvantages include an obvious doubling in thickness and weak points in the hinge area.

U.S. Pat. No. 4,660,223, to Fritch, discloses a semi-flexible articulated titanium aramid and felt armor and the adopting of male armor by adding additional spacers of foam to reduce pressure on the breasts. U.S. Pat. No. 6,233,737, to Ditchfield et al, discloses male body armor side panels which are cut with one side panel edge concave and the other convex to provide a “ball and socket” formation and additionally discloses an adaptation of a male design to form bust contours by simply cutting notches in the sides of the front panel, thus allowing the vest to bend from a horizontal concave form similar to the Zufle '223 patent with obvious protection disadvantages (FIGS. 4A and 4B).

Other attempts to provide contoured body armor panels for females still fail to produce optimal results. U.S. Pat. No. 6,034,004, and U.S. Pat. No. 6,048,486, Fels et al, disclose a cavity for breasts molded in each layer of flat pane woven ballistics fabric utilizing temperatures between 180° and 300° C. and pressures between 58 to 116 psi. This method allows warp and weft ends to slide into the contour area during forming, but resins are not used to obtain permanent deformation. This approach provides less than optimum, poorly defined, cavity-like shapes, long molding cycle times, higher labor costs and a high perimeter waste. It does, however, improve the female-like contour without some of the thick or thin areas of the prior art.

It is also known that additional layers of ballistic material may be placed in four to five inch strips over the spine and sternum to add protection in soft non-composite body armor. U.S. Pat. No. 6,941,585, to Wells, discloses a design of ballistic vests and belts, with added reinforcing materials at the edges, which are stiffer and thicker than the garment itself, providing cost, wearability and concealability disadvantages.

It remains clear that a need exists, not met by the prior art, to provide comfortable, flexible, and non-obvious body armor, conforming to the female torso, and optionally providing added protection for the areas of the breasts, sternum, spine and edges, without significantly increasing bulk or decreasing comfort or concealability. The present invention is directed to such purpose.

### SUMMARY OF THE INVENTION

This invention is directed to the provision of a contoured, form-fitting flexible body armor torso panel for a protective vest, primarily for ballistic protection, and, additionally, for protection from blunt trauma, or stabbing, or other penetrating instrument trauma. More specifically, the invention is directed toward form-fitting torso conforming body armor panels, adaptable both for males or females, and contoured to both the front torso and back torso of both males and females.

The torso conforming panels utilize woven ballistic fabric, in multiple adjoining sheets, in substantial parallel with each other. In order to facilitate the torso conforming feature of the invention, each sheet of the woven ballistic material is made of weft (fill) and warp yarns having a long float weave in one or more directions. The weft (fill) and warp yarns of the sheet of anti-ballistic fabric are yarns which have high fiber strength with a minimum tenacity of 20 grams per denier with a minimum break elongation of 2% and a minimum initial tensile modulus of 350 grams per denier. “Denier” is a unit of weight indicating the fineness of fiber filaments in yarns, one denier being equal to a yarn weighing one gram per each 9,000 meters. Yarns which may be used utilizing the above criteria include para aramids, yarns constructed of ultrahigh molecular weight polyethylene, co-polymer aramids, poly p-phenyl benzobisoxazole (PBO), poly p-phenyl-diimidazo-pyridinylene-dihydroxy-phenylene (PIPD/M5), single walled carbon nanotubes (SWNT), and multi-walled carbon nanotubes (MWNT). The purposes of the invention are met with fabrics containing yarns which are solely comprised of one of these fibers, or comprised of these fibers in any combination. Typical fabrics which incorporate such long float weaves and which facilitate the purpose of the invention include balanced twill weaves, with weft and warp floats in ranges of 3×3 to 12×12, unbalanced twill weaves, where the number of warp yarns exceeds the number of weft, or fill, yarns by 1 to 3 yarns per inch; balanced satin, or sateen weaves having float ratios which are within a range of 5 to 1 to 12 to 1; unbalanced satin weaves where the number of warp yarns exceeds the number of fill, or weft yarns within a range of 1 to 3 per inch; balance satin weaves having a float ratio within a range of 5 to 1 to 12 to 1, where, in such weaves, the yarn interlace points of the weft and warp yarns are irregularly spaced, in quasi-random, or low discrepancy, sequences, and in such unbalanced satin weaves where the number of warp yarns exceeds the number of fill yarns within the previously mentioned range of 1 to 3 per inch. In the long float weaves of the unbalanced twill, where the number of warp yarns exceeds the number of fill yarns by as many as three per inch, advantage is gained by utilizing fewer picks than ends. References to “satin” and “sateen” in terms of the fabric are virtual equivalents, as the only difference in a satin and a sateen fabric is the directional method of weaving. A satin fabric has long floats in the fabric face in a warp direction, while a sateen has the long floats in the weft direction. Thus, if the technical face of the fabric is a satin, then technical back is a sateen. Because there is no difference in the functional use of the fabric in terms of which face of the fabric is “up,” “satin” and “sateen” are used here, and in the Claims, interchangeably. When the term “balanced” is used in describing a weave of the invention, it is used to indicate equal numbers of ends and picks. When the ballistic fibers are woven, the machine direction of the loom may be alternatively referred to as warp, warped ends, or ends, while the cross direction fibers on the loom are variously referred to picks, fill, or weft yarns.

The adjoining sheets of the ballistic fabric are, taking advantage of the long floats of the fabric as previously described, contoured to a specific form-fitting torso shape. This shape confirmation may be as simple as adjusting to simple size and relative dimensions of different male torsos or, more radically, and as a specific feature of this invention, specifically radically contoured to take into account breast areas in different sizes and shapes for individual female contours. When contoured, the long floats of the fabric are held in shape to maintain the desired torso contour by adhesive which is applied to the adjoining sheets. The adhesive is applied in a manner which not only holds the adjoining sheets to each other, but also holds the weft and warp (fill) yarns of the long float fabric of each sheet in the contoured shape, permanently. A preferred adhesive for this use is a eutectic ethylene co-polymer elastomeric adhesive, or other similar adhesive which will hold the individual yarns of each sheet of fabric and the adjoining fabric sheets in place when cured, without becoming brittle.

The contoured panels may be provided for the front torso of an individual, as well as the back. They are held together in a vest configuration by shoulder straps and side straps joining the panels together at the edges.

Utilizing the fabrics and adhesives, as mentioned, the form-fitting flexible body armor panels are constructed by aligning the desired number of corresponding sheets of the woven ballistic fabric, as previously described, cut into correspondingly shaped sheets in the desired outline shape of the body panel. Adhesive resin is then applied in a manner which impregnates the yarns of each sheet. In the preferred embodiment, the adhesive resin is applied to each sheet. However, any manner of application is satisfactory, so long as the adhesive resin is applied to all of the yarns in each sheet of fabric, so that, when cured, they will be cured in torso conformed position. The multiple layers of woven ballistic fabric are then placed in a preformed mold, conformed to the desired body contour for the panel. Such a mold has an upper and lower portion, each conforming to the desired shape so that, when the mold portions are placed together with the fabric layers between them, the sheets of fabric with applied adhesive are compressed between the upper and lower portions of the mold, and the long floats of the chosen fabric weave allow the fabric to conform to the shape of the mold. The mold is then placed under pressure forcing the opposing surfaces of the mold together with sheets of fabric with adhesive thereon compressed between them. Relatively lower pressures are utilized in this procedure and an optimum range of performance is to provide pressure to the fabric within the mold within a range of 15 pounds per square inch to 40 pounds per square inch. While the multiple sheets of the woven ballistic fabric which comprise the body armor torso panel are in the mold, relatively low heat is applied, within a desired optimum range of 200° to 260° F. to cure the adhesive. When the adhesive is cured, the panel is removed from the mold.

Additional features of the invention include the ability to add additional layers of the long float weave ballistic fabric along the areas of the panel where greater protection may be required or desired. These areas include the edges of the panel, where the ability of the fabric to withstand penetration may be less, the spine area of a back torso panel, and the sternum and breast areas of a front torso panel. Separate protection of these areas utilizing the same fabric allows the additional protective layers to be molded in body conforming shape in the same manner as the full primary panels. Alternatively, additional protection may be provided by providing stripped pieces or cups of rigid non-fabric anti-ballistic materials and separately adhering them to the exterior of the torso conforming panel, or between layers of the torso conforming panel. The torso conforming body panels as described, relative to the present invention, are intended not only to provide anti-ballistic protection, but protection from blunt instrument trauma, and, in some circumstances, trauma by cutting or piercing instruments such as knives, picks and the like, as well.

The above and additional features of the invention may be considered and will become apparent in conjunction with the drawings in particular and the detailed description which follows.

### BRIEF DESCRIPTION OF THE DRAWINGS

FIG. 1 is an example of the prior art presenting a schematic, showing a central section and corresponding two side sections of ballistic materials overlapped and sewn together to comprise a vest panel.

FIG. 2 is an example of prior art depicting potential locations for forming fabric darts without cutting the ballistic fabric. Dotted lines demonstrate where the materials are folded to form the darts or pleats and then flattened against the plane of the ballistic pad along either solid line and sewn.

FIG. 3 is an example of the prior art, showing a rudimentary, horizontal “bust pocket” created by cutting ballistic panels horizontally on each side and folding the panels to form a shape.

FIG. 4A is a view of a ballistic panel with cut out sections to promote shaping.

FIG. 4B shows the prior art panel of FIG. 4A in shaped perspective, and the resultant gaps in protecting of the size of the bust.

FIG. 5 is a representation of a typical prior art two-directional “plain weave” of ballistic fibers, with a float ratio of 1:1.

FIG. 6 demonstrates a two-directional ballistic fabric weave, having a float of three strands, in each direction, also described as a 3×3 twill weave.

FIG. 7 demonstrates a two-directional ballistic fiber weave having a long float ratio of 1:6, which is typical of a satin or sateen weave.

FIG. 8 demonstrates a two-directional ballistic fiber weave in which the warp or fill yarn interlace points are irregularly spaced in quasi-random, or low discrepancy, sequences, and is also described as a “faux sateen” weave.

FIG. 9 is a front view of a single piece, shaped and molded female body armor panel with dotted lines demonstrating strategic areas of the breast, sternum, and edges, where optional, additional specific ballistic fabric layers may be added for additional protection.

FIG. 10 is an exploded view of a mold for a contoured body armor panel for a female front, with layers of ballistic fabric and resin application between the fabric layers.

FIG. 11 is a perspective view of a contoured body armor panel of the current invention worn by a female user.

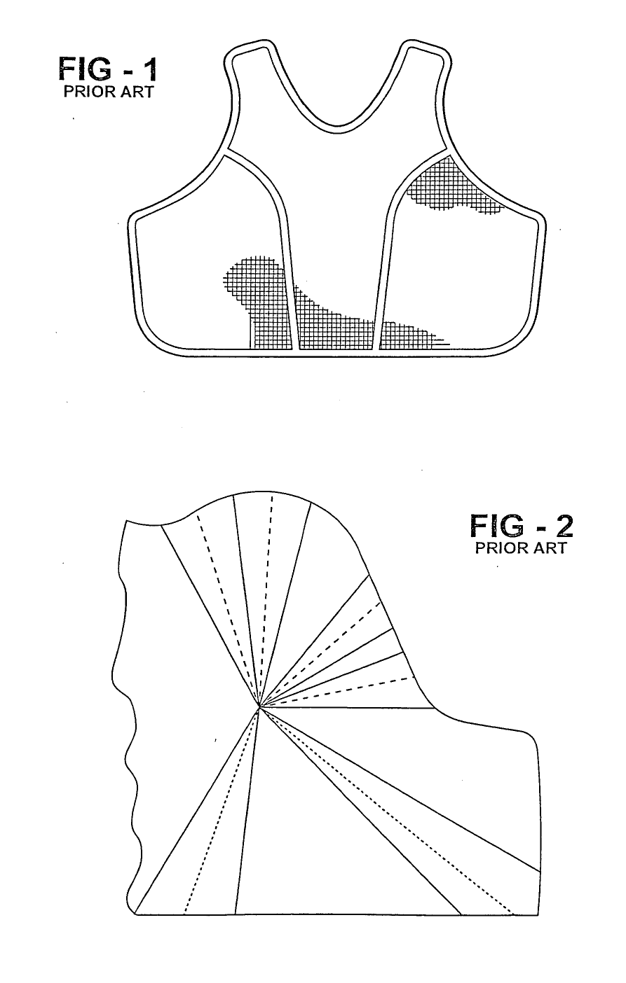

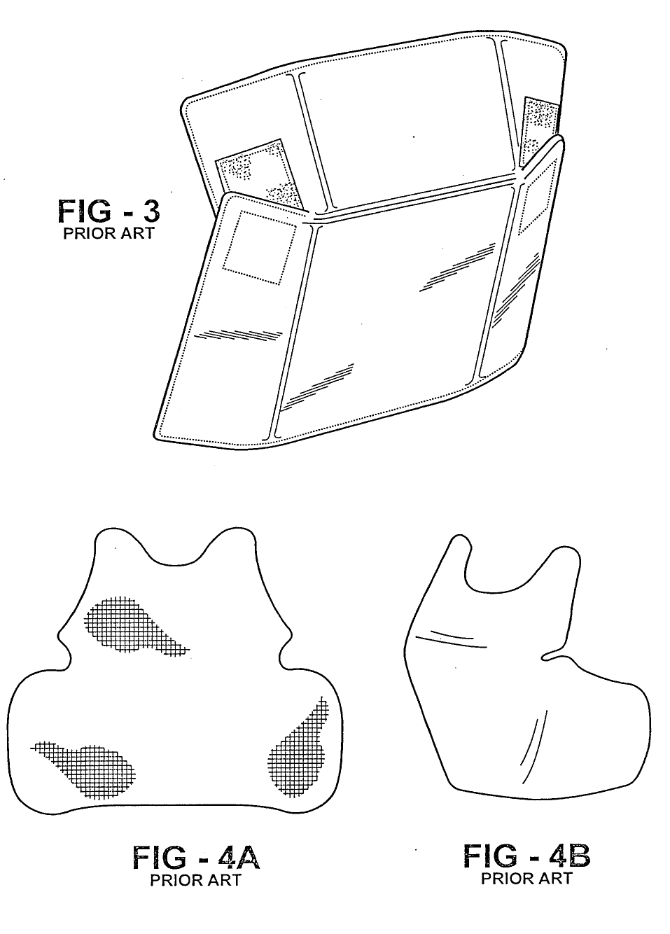

### DETAILED DESCRIPTION OF THE PREFERRED EMBODIMENT

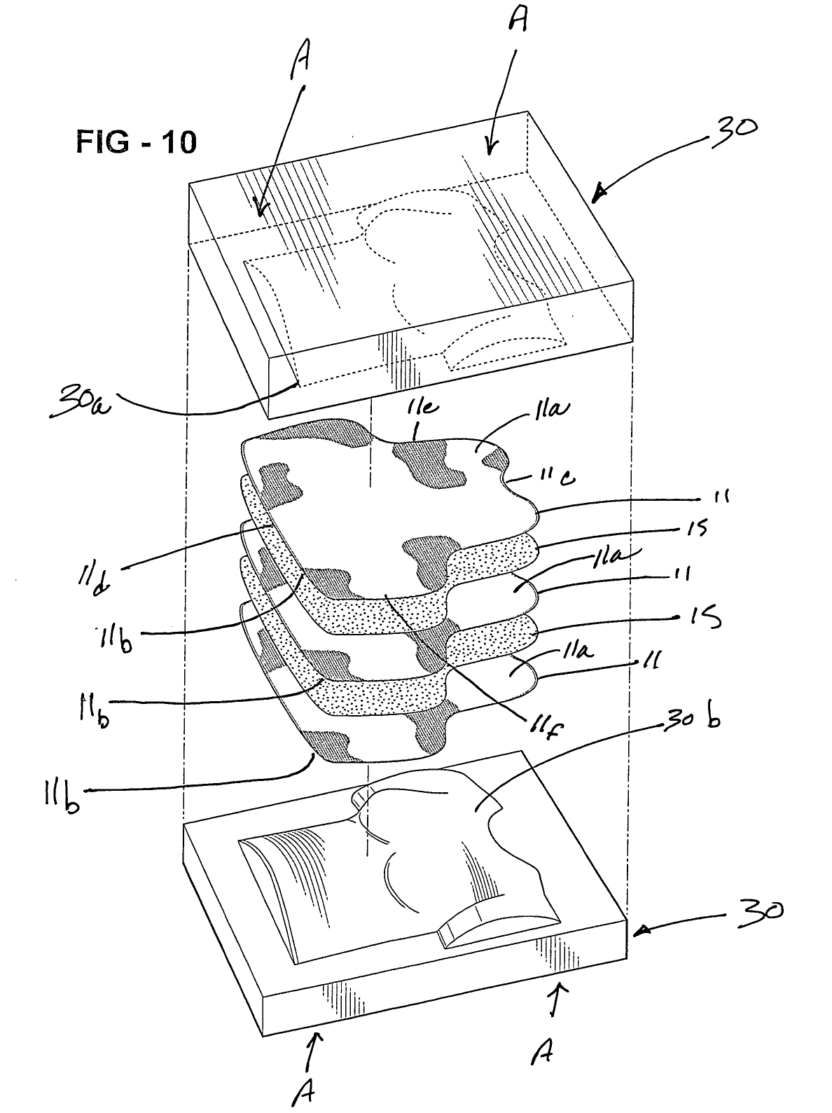

The invention, Molded Torso-Conforming Body Armor and Method of Producing Same, broadly considered, includes a contoured, form-fitting torso panel 10. Panel 10 is formed from two or more adjoining sheets 11 of woven ballistic fabric, each sheet 11 having an upper side 11a and an underside 11b, as well as a top border 11c, bottom border 11d, first side border 11e and second side border 11f. All of the adjoining sheets 11 are substantially uniform size and shape with borders 11c, 11d, 11e and 11f, substantially conforming as shown in FIG. 10. Each sheet 11 is in parallel contact with at least one other adjoining sheet 11, with said parallel contact being between upper side 11a of one sheet and the underside 11b of the immediate adjoining sheet 11.

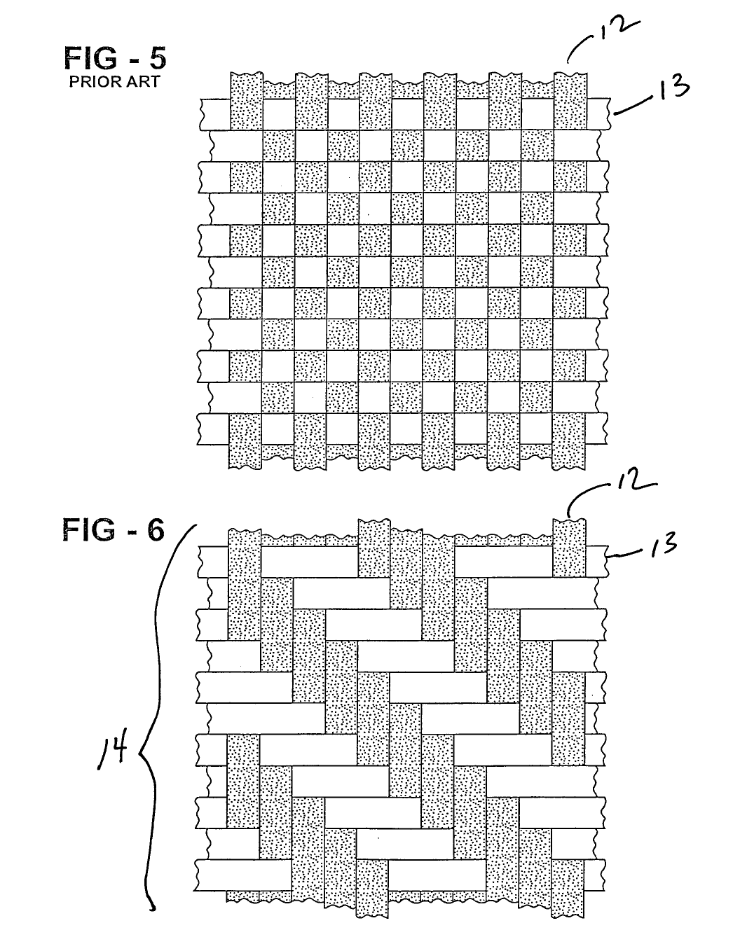

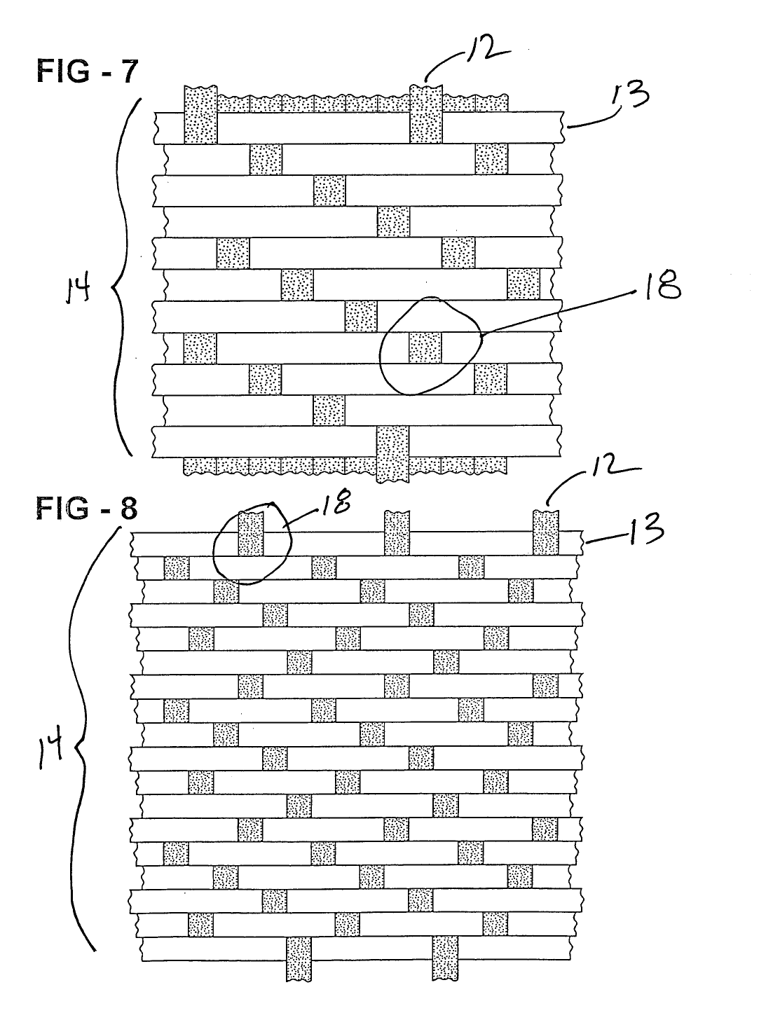

The woven ballistic fabric of each sheet 11, as formed, is constructed of weft yarns 12 and warp, or fill yarns, 13, in a long float weave 14 in at least one direction, as shown in FIGS. 6, 7, and 8.

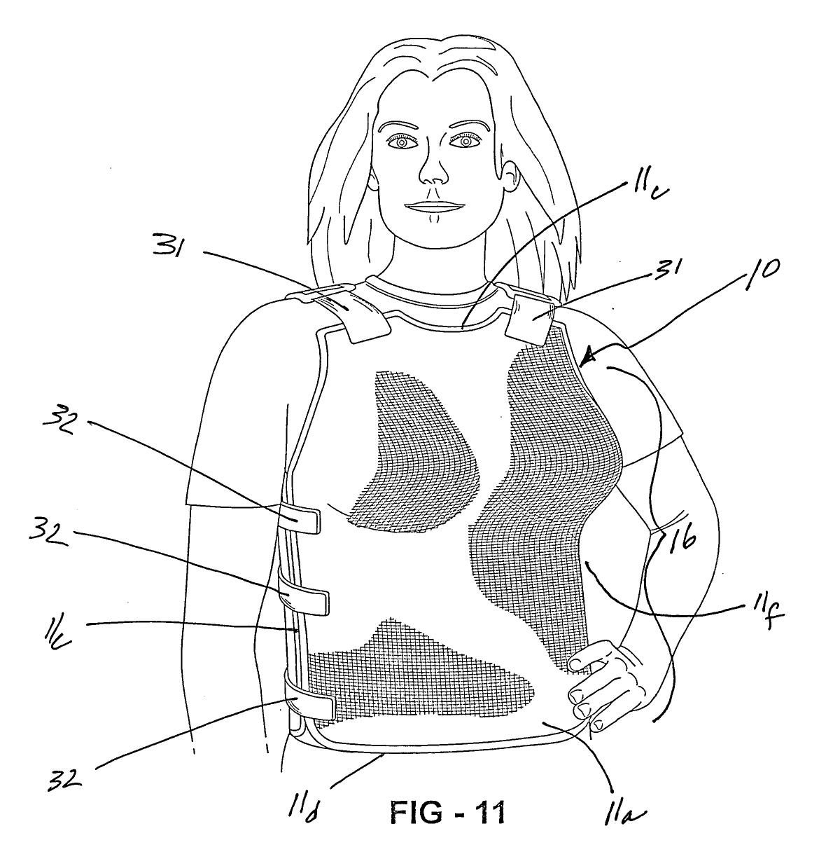

An adhesive means 15, as shown in FIG. 10, is used to hold the corresponding upper side 11a and under side 11b of adjoining sheets 11 together and also to bind and hold the weft yarns 12 and warp yarns 13 in place after the combination of adjoining fabric sheets 11 has been formed into a desired contour shape 16 as demonstrated in FIG. 11. The adhesive 15 is applied to the fabric sheets 11 between an upper side 11a and corresponding under side 11b of adjoining sheets 11. The adhesive 15 may be applied to the corresponding side 11a, side 11b or both sides 11a and 11b, of the adjoining sheets 11.

The adhesive 15 is applied to the fabric sheets 11 in an uncured state, and cured when panel 10 has been contoured into a specific form-fitting shape 16 as demonstrated by the female torso shape 16 of FIG. 11. The long float weave 14 allows each fabric sheet 11 of panel 10 to be simultaneously contoured into the specific shape 16, and held in such shape 16 when the adhesive is cured. Such contour shaping 16 of fabric sheets 11 and panel 10, to the extent of the present invention, is a feature of the invention not available with conventional ballistic fabrics of the prior art as shown in FIG. 5, which do not utilize a long float weave 14.

Without limiting the invention thereto, long float weave 14 for any fabric sheet 11 of the present invention may include balanced twill weaves having weft 12 and warp 13 floats in ratios of three to three (3:3) to twelve to twelve (12:12); unbalanced twill weaves where the number of warp yarns 13 exceeds the number of weft yarns 12, within a range of one to three (1-3) per inch; balance satin weaves having a float ratio within a range of five to one (5:1) to twelve to one (12:1); unbalanced satin weaves where the number of warp yarns 13 exceeds the number of weft yarns 12 in a ratio of one to three (1:3) per inch; balanced satin weaves having a float ratio within a range of five to one (5:1) to twelve to one (12:1) where the long float weave 14 has interlaced points 18 for the weft yarn 12 and warp yarn 13, randomly and irregularly spaced; as well as unbalanced satin weaves where the number of warp yarns 13 exceeds the number of weft yarns 12 within a range of one to three (1-3) per inch.

As stated, the terms “weft” and “fill” may be used interchangeably, as may the terms “warp” and “machine.” Likewise, for purposes of the present invention, requirement for, or reference to, a specific ratio or relationship of weft yarns 12 to warp yarns 13, in a described long float weave 14, may be met by providing a weave 14, wherein the cited ratio is reversed.

Adhesive 15 may be an eutectic ethylene copolymer elastomeric adhesive or other adhesive having similar elastic properties when cured. In the preferred embodiment, the adhesive 15 is cured by low heat (increased temperature), optimally within a range of 200° to 260° F.

In the preferred embodiment, the yarns 12 and 13 of long float weave 14, of the woven ballistic fabric are comprised of high strength fibers having a minimum tenacity of 20 grams per denier, a minimum break elongation of 2% and a minimum initial tensile modulus of 350 grams per denier. In the preferred embodiment, said yarns 12 and 13 may be constructed of or formed of poly p-phenyl benzobisoxazole (PBO), poly p-phenyl-diimidazo-pyridinylene-dihydroxy-phenylene (PIPD/M5), single walled carbon nanotubes (SWNT), multi-walled carbon nanotubes (MWNT), ultra high molecular weight polyethylene (UHMWP), co-polymer aramids and para aramids or others having like properties. The composition of yarns 12 and/or 13 may be of any of the above materials, individually or in any combination of two or more of said group.

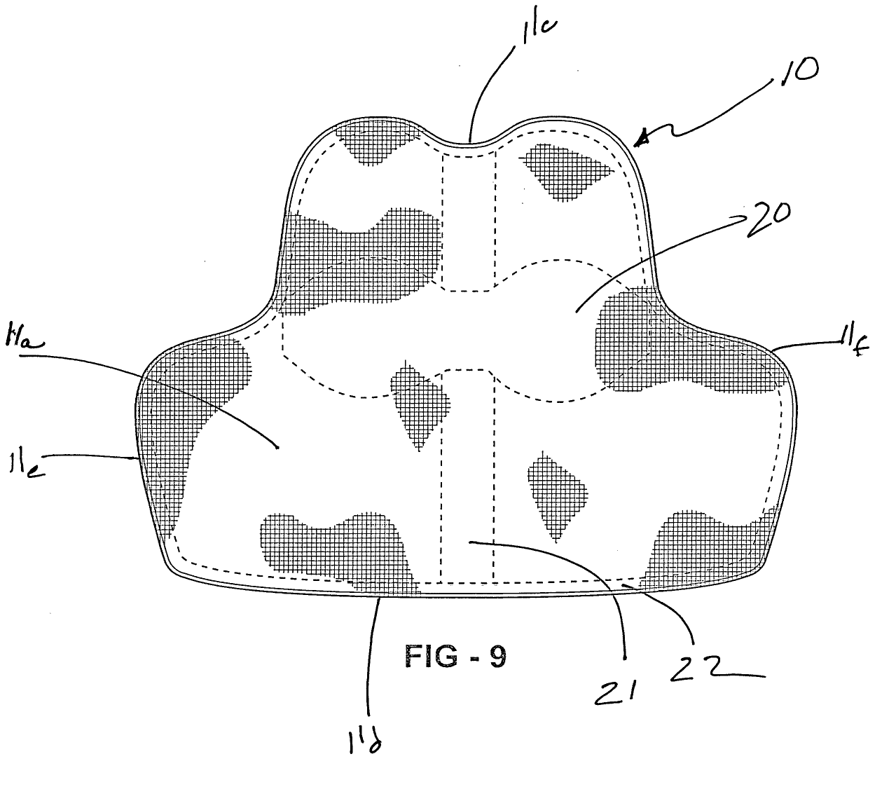

In a featured embodiment of the invention, additional partial layers of the woven ballistic fabric used for sheet 11 may, with additional adhesive 15, be provided on specific but limited areas of panel 10, as shown in FIG. 9, where additional ballistic fabric layers are shown to the breast area 20, sternum area 21, and perimeter area 22, which perimeter area 22 continuously covers top border 11c, bottom border 11d, first side border 11e and second side border 11f. For a panel designed to cover the user's back, extra limited fabric layers may also be applied, as an example, over the spine area, and/or kidneys, or any other areas which could require additional protection, either generally, or as a custom feature for a particular wearer. Areas such as breast area 20, sternum area 21, perimeter area 22, as well as other areas, such as the referenced spine, kidney and/or other applications, may be protected by additional layers of rigid anti-ballistic material also. The contoured form fitting panel 10, while constructed of anti-ballistic fabric in the manner described above, is designed and constructed not only to protect against hand gun bullets, but also against steel fragment simulating projectiles, right circular cylinders and/or spheres designed to represent fragments generated by explosive devices, and, in conjunction with additional overlying strike plates, against rifle bullets. Panel 10, including any additional fabric layers 20, 21, 22, or otherwise, in addition to anti-ballistic protection, may also simultaneously afford the user protection from stab or other trauma injury.

The invention embodied in panel 10, as described above, is constructed by (a) selecting a desired ballistic fabric comprised of weft yarns 12 and warp yarns 13, and a long float weave 14; (b) cutting the fabric to provide the desired quantity of corresponding sheets 11, in the desired outline for the particular contour and outlying shape of panel 10, each sheet 11 having substantially conforming corresponding planar areas, upper sides 11a, under sides 11b, top border 11c, bottom border 11d, first side border 11e and second side border 11f; (c) applying an adhesive 15 in resin or other form, of the type described above, between each sheet 11 of fabric, as to each pair of adjacent sheets 11, either to the upper side 11a of the sheet 11 adjacent to the corresponding sheet 11 or the underside of 11b, the sheet 11 adjacent to the corresponding sheet 11, or to both. In the preferred embodiment, the adhesive 15 impregnates the yarns 12 and 13 of the long float weave 14 of each sheet 11. The adhesive 15 may be applied with an applicator or may be an adhesive 15 sheet placed upon the adjacent sheet 11 prior to the below molding and curing steps; (d) a pre-formed mold 30, having an upper torso mold surface 30a and a lower torso mold surface 30b, correspondingly conformed so that the raised portion of the lower mold surface 30b is conformed in a convex replica of the desired torso contour with the upper torso mold surface 30a being correspondingly conformed in concave manner so that the corresponding convex surface 30b and concave surface 30a which oppose each other, fit together in a male-female relationship when the lower surface 30b and upper surface 30a of mold 30 are moved together as shown in FIG. 10, and placing the desired number of sheets 11 of the anti-ballistic material between the mold surfaces 30a and 30b with said applied adhesive 15. Two or more (as desired) sheets 11 with adhesive 11 applied between each corresponding and adjoining pairs of sheets, all sheets 11 being in substantially parallel contact within the mold 11. (e) applying an opposing pressure A to the mold 30 from either or both sides forcing surface 30a and 30b together, with sheets 11 and applied adhesive 15 forced together and compressed between said surfaces 30a and 30b. In the preferred embodiment of the invention and method, pressure A is applied to compress the mold surfaces 30a and 30b against each other within a range of 15 p.s.i. to 40 p.s.i.; (f) while under said pressure A, adhesive 15 is cured by applying low heat (increased temperature) which, in the preferred embodiment, is within a range of 200 to 260 F.; (g) upon cure, the panel 10 in contoured form is shown in FIG. 11, is removed from the mold 30.

In a further embodiment of the invention, multiple panels 10, contoured to fit different portions of the wearer's body, such as a front panel as shown in FIG. 11, and a back panel, not shown, but suggested by FIG. 11, may be placed together by fastening means such as shoulder straps 31 and side straps 32 to form a complete anti-ballistic garment.

Whereas, a preferred embodiment of the invention has been illustrated and described in detail, this detailed disclosure is without limitation of various changes which may be made in a disclosed embodiment without departing from the spirit of the invention as disclosed.

What is claimed is:

1. A contoured, form-fitting flexible body armor torso panel further comprising:
a plurality of adjoining sheets of woven ballistic fabric, each sheet in parallel contact with at least one adjoining sheet of fabric, each said sheet having an upper side, an under side, a top border, a bottom border, first side border, and second side border;
said woven ballistic material comprised of weft and warp yarns having a long float weave in one or more directions;
said plurality of fabric sheets contoured to a specific form-fitting shape;
an adhesive means holding said adjoining sheets to each other and holding the yarns of said long float weave of each sheet in said contoured shape.

2. The invention of claim 1, wherein said long float weave is a balanced twill weave with weft and warp floats in ranges from 3×3 to 12×12.

3. The invention of claim 1, wherein said long float weave is an unbalanced twill weave with the number of warp yarns exceeding the number of weft yarns being within a range of 1 to 3 per inch.

4. The invention of claim 1, wherein said long float weave is a balanced satin weave having a float ratio within a range of 5:1 to 12:1.

5. The invention of claim 1, wherein said long float weave is an unbalanced satin weave with the number of warp yarns exceeding the number of weft yarns within a range of 1 to 3 per inch.

6. The invention of claim 1, wherein said long float weave is a balanced satin weave having a float ratio within a range of 5:1 to 12:1, said weave further comprising yarn interlace points irregularly spaced in quasi-random sequence.

7. The invention of claim 6, wherein said long float weave is an unbalanced satin weave and the number of warp yarns exceeds the number of weft yarns within a range of 1 to 3 per inch.

8. The invention of claim 1, wherein said adhesive comprises a eutectic ethylene copolymer elastomeric adhesive.

9. The invention of claim 1, wherein the yarns of the woven ballistic fabric are of a high strength fiber having a minimum tenacity of 20 grams per denier, a minimum break elongation of 2% and a minimum initial tensile modulus of 350 grams per denier.

10. The invention of claim 9, wherein the yarns of the woven ballistic material are selected from a group of yarns comprised of poly p-phenyl benzobisoxazole, poly p-phenyl-diimidazo-pyridinylene-dihydroxy-phenylene, single walled carbon nanotubes, multi-walled carbon nanotubes, ultra high molecular polyethylene, co-polymer aramids and para aramids.

11. The invention of claim 10, wherein said yarns are comprised of a combination of two or more of said group.

12. The invention of claim 1, wherein one or more additional partial layers of said woven ballistic fabric are provided on specified limited areas of the body armor torso panel.

13. The invention of claim 12, wherein said additional partial layers are provided in one or more areas of a group comprised of the breast area, sternum, spine, and panel edges.

14. The invention of claim 1, wherein additional protective layers of rigid anti-ballistic material are provided on specified limited areas of the body armor torso panel.

15. A method of constructing a form-fitting flexible body armor panel comprised of the following steps:
a. Providing a woven ballistic fabric comprised of weft and warp yarns having a long float weave in one or more directions;
b. Cutting the fabric to provide a plurality of substantially corresponding sheets in the desired outline shape of the body panel, each said sheet having an upper side, an under side, a top border, a bottom border, first side border, and second side border.
c. Applying an adhesive resin to each sheet of woven ballistic fabric.
d. Providing a pre-formed mold of the desired body contour for the panel and placing therein the plurality of sheets of material, with said adhesive, said plurality of sheets being in parallel contact with one another within the mold. Said mold further having an upper surface and an opposing lower surface.
e. Providing pressure, forcing the opposing surfaces of the mold together, with the sheets of fabric and adhesive compressed between the opposing portions of the mold.
f. Curing said adhesive.
g. Removing the cured body armor panel from the mold.

16. The method of claim 15, wherein pressure in a range of 15 psi to 40 psi is utilized in step e, to force the opposing surfaces of the mold together.

17. The method of claim 15, wherein, in step f, the adhesive is cured by applying increased temperature.

18. The method of claim 15, wherein said long float weave is a balanced twill weave with a weft and warp floats within a range of from 3×3 to 12×12.

19. The method of claim 15, wherein said adhesive comprises a eutectic ethylene copolymer elastomeric adhesive.

20. The method of claim 15, wherein the woven ballistic fabric yarns are of a high strength fiber having a minimum tenacity of 20 grams per denier, a minimum break elongation of 2% and a minimum initial tensile modulus of 350 grams per denier.

21. The method of claim 20, wherein the yarns of the woven ballistic material are selected from a group of yarns comprised of poly p-phenyl benzobisoxazole, poly p-phenyl-diimidazo-pyridinylene-dihydroxy-phenylene, single walled carbon nanotubes, and multi-walled carbon nanotubes, ultra high molecular polyethylene, co-polymer araminds and para aramids.

22. The method of claim 15, wherein the yarns of said woven ballistic material are selected from a group of yarns comprised of a combination of two or more of said group.

23. The method of claim 15, wherein one or more additional partial layers of said woven ballistic fabric are provided on specified limited areas of the body armor torso panel.

24. The invention of claim 23, wherein said additional partial layers are provided in one or more areas of a group comprised of the breast area, sternum, spine, and panel edges.

25. The invention of claim 15, wherein additional protective layers of rigid anti-ballistic material are provided on specified limited areas of the body armor torso panel.

26. The invention of claim 15, wherein said long float weave is an unbalanced twill weave with the number of warp yarns exceeding the number of weft yarns being within a range of 1 to 3 per inch.

27. The invention of claim 15, wherein said long float weave is a balanced satin weave having a float ratio within a range of 5:1 to 12:1.

28. The invention of claim 15, wherein said long float weave is an unbalanced satin weave with the number of warp yarns exceeding the number of weft yarns within a range of 1 to 3 per inch.

29. The invention of claim 15, wherein said long float weave is a balanced satin weave having a float ratio within a range of 5:1 to 12:1, said weave further comprising yarn interlace points irregularly spaced in quasi-random sequence.

30. The invention of claim 15, wherein said long float weave is an unbalanced satin weave and the number of warp yarns exceeds the number of weft yarns within a range of 1 to 3 per inch.

31. The invention of claim 18, wherein the applied increased temperature is in a range of 200° to 260° F.
